(19) United States
(12) Patent Application Publication
(10) Pub. No.: US 2007/0264552 A1
(43) Pub. Date: Nov. 15, 2007

(54) FUEL CELL

(75) Inventors: Naoya HAYAMIZU, Kanagawa-ken (JP); Jun Momma, Kanagawa-ken (JP); Kazuhiro Yasuda, Kanagawa-ken (JP); Yoshihiko Nakano, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/685,980

(22) Filed: Mar. 14, 2007

(30) Foreign Application Priority Data
Mar. 15, 2006 (JP) 2006-071632

(51) Int. Cl. H01M 8/10

(52) U.S. Cl. 429/30

(57) ABSTRACT

A fuel cell which generates electricity by using a fuel and oxygen, includes: an anode; a cathode; and a plate-like member provided between the anode and the cathode, the plate-like member including: a matrix having a plurality of through holes; and an electrolytic material buried in the through holes. The electrolytic material allows passage of protons and preventing passage of the fuel. The through holes have an aperture ratio distributed in the plate-like member so that the plate-like member has a uniform in-plane temperature when reaction between the anode and the cathode reaches a steady state.

### CROSS-REFERENCE TO RELATED APPLICATIONS

This application is based upon and claims the benefit of priority from the prior Japanese Patent Application No. 2006-071632, filed on Mar. 15, 2006; the entire contents of which are incorporated herein by reference.

### BACKGROUND OF THE INVENTION

1. Field of the Invention

This invention relates to a fuel cell, and more particularly to a direct liquid fuel cell.

2. Background Art

With the advancement of electronics in recent years, electronic devices have become more compact, more powerful, and more portable. In particular, mobile electronic devices require higher energy density for the cells used therein. Hence lightweight and small secondary cells having high capacity are required.

To meet such requirements for secondary cells, lithium ion secondary cells are conventionally developed. However, the operation time of mobile electronic devices tend to further increase. Lithium ion secondary cells are approaching the limit of improvement in energy density from the viewpoint of both material and structure, and becoming unable to respond to further requirements.

Under these circumstances, instead of lithium ion secondary cells, small fuel cells are attracting attention. In particular, the direct methanol fuel cell (DMFC) using methanol as its fuel is free from difficulty in handling hydrogen gas as compared with fuel cells based on hydrogen gas, and needs no systems for reforming an organic fuel to produce hydrogen. Thus the DMFC is considered easy to downsize.

A DMFC has a fuel electrode (anode), a solid electrolyte plate (plate-like member), and an air electrode (cathode) provided adjacent to each other in this order. At the fuel electrode, methanol is decomposed by oxidation into carbon dioxide, protons, and electrons. On the other hand, at the air electrode, water is generated from oxygen obtained from air, protons supplied from the fuel electrode through the electrolyte plate, and electrons supplied from the fuel electrode through an external circuit. At this time, passage of electrons through the external circuit supplies electric power to this external circuit.

Conventional DMFCs generate electricity in this configuration. Hence a pump for supplying methanol and a blower for feeding air are attached thereto as auxiliaries and complicate the overall configuration. Thus the DMFCs of this configuration are difficult to downsize.

In this connection, a technique for reducing the distance between the methanol tank and the electricity generating device is recently developed. In this technique, instead of using a pump to supply methanol, a membrane allowing passage of methanol molecules is provided between the methanol tank and the electricity generating device. With regard to air intake, a technique is developed for directly attaching air inlets to the electricity generating device without using a blower. Thus a DMFC can be significantly downsized by omitting the pump and blower therefrom (see, e.g. JP 2002-105220A).

However, although this type of DMFC has a simplified and downsized configuration, it is susceptible to external environmental factors such as temperature. For example, when the temperature increases, methanol passes through the electrolyte plate between the anode and the cathode. Unfortunately, this phenomenon, called “methanol crossover”, significantly decreases the electricity generating efficiency.

Furthermore, this type of DMFC has a problem of in-plane variation in reaction rate. In-plane variation in reaction rate causes a region in the electrolyte plate to occur where the temperature is higher or the amount of passing protons is larger than in the other region. Then the region is deteriorated earlier than the other region and decreases the overall lifetime of the electrolyte plate.

### SUMMARY OF THE INVENTION

According to an aspect of the invention, there is provided a fuel cell which generates electricity by using a fuel and oxygen, comprising: an anode; a cathode; and a plate-like member provided between the anode and the cathode, the plate-like member including: a matrix having a plurality of through holes; and an electrolytic material buried in the through holes, the electrolytic material allowing passage of protons and preventing passage of the fuel, and the through holes having an aperture ratio distributed in the plate-like member so that the plate-like member has a uniform in-plane temperature when reaction between the anode and the cathode reaches a steady state.

According to another aspect of the invention, there is provided a fuel cell which generates electricity by using a fuel and oxygen, comprising: an anode; a cathode; and a plate-like member provided between the anode and the cathode, the plate-like member including: a matrix having a plurality of through holes; and an electrolytic material buried in the through holes, the electrolytic material allowing passage of protons and preventing passage of the fuel, and the through holes having an aperture ratio distributed in the plate-like member so that the plate-like member has a uniform in-plane proton passage density when reaction between the anode and the cathode reaches a steady state.

According to another aspect of the invention, there is provided a fuel cell which generates electricity by using a fuel and oxygen, comprising: an anode; a cathode; and a plate-like member provided between the anode and the cathode and allowing passage of protons, the plate-like member including: a matrix having a plurality of through holes; and an electrolytic material buried in the through holes, the electrolytic material allowing passage of protons and preventing passage of the fuel, and a fuel supply port configured to supply the fuel to the anode being placed on the opposite side of the plate-like member as viewed from the anode, and the aperture ratio of the through holes in a central region of the plate-like member being lower than the aperture ratio of the through holes in a peripheral region of the plate-like member.

According to another aspect of the invention, there is provided a fuel cell which generates electricity by reaction of fuel and oxygen, comprising: an anode; a cathode; and a plate-like member provided between the anode and the cathode and allowing passage of protons, the plate-like member including: a matrix having a plurality of through holes; and an electrolytic material buried in the through holes, the electrolytic material allowing passage of protons and preventing passage of the fuel, and a fuel supply port configured to supply the fuel to the anode is placed on one end side of the anode, and the aperture ratio of the through holes in a region on the one end side of the plate-like member being lower than the aperture ratio of the through holes in a region on the other end side of the plate-like member.

### BRIEF DESCRIPTION OF THE DRAWINGS

FIG. 1 is a cross-sectional view illustrating a fuel cell according to a first embodiment of the invention.

FIG. 2 is a plan view illustrating an electrolyte plate of the fuel cell according to a first example of the first embodiment.

FIG. 3 is a plan view illustrating an electrolyte plate of the fuel cell according to a second example of the first embodiment.

FIG. 4 is a plan view illustrating an electrolyte plate of the fuel cell according to a third example of the first embodiment.

FIG. 5 is a cross-sectional view illustrating a fuel cell according to a second embodiment of the invention.

FIG. 6 is a plan view illustrating an electrolyte plate of the fuel cell according to a first example of the second embodiment.

FIG. 7 is a plan view illustrating an electrolyte plate of the fuel cell according to a second example of the second embodiment.

FIG. 8 is a plan view showing an electrolyte plate of a fuel cell according to a comparative example.

### DETAILED DESCRIPTION OF THE INVENTION

Embodiments of the invention will now be described with reference to the drawings.

To begin with, a first embodiment of the invention is described.

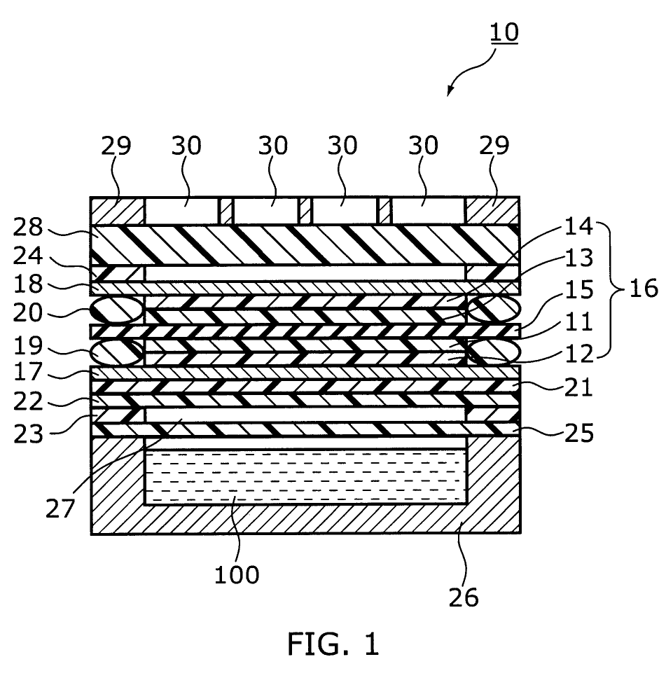

FIG. 1 is a cross-sectional view illustrating a fuel cell according to this embodiment.

A fuel cell 10 according to this embodiment is illustratively a direct methanol fuel cell. This fuel cell 10 comprises a fuel electrode (anode) composed of a fuel electrode catalyst layer 11 and a fuel electrode gas diffusion layer 12, and an air electrode (cathode) composed of an air electrode catalyst layer 13 and an air electrode gas diffusion layer 14. The fuel cell 10 further comprises an electrolyte plate (plate-like member) 15 held between the fuel electrode catalyst layer 11 and the air electrode catalyst layer 13 and having proton (hydrogen ion) conductivity. The fuel electrode, the electrolyte plate, and the air electrode are all shaped like a flat plate. The fuel electrode, the electrolyte plate 15, and the air electrode are laminated in this order to constitute a membrane electrode assembly (MEA) 16, which serves as an electromotive section of the fuel cell 10.

The electrolyte plate 15 has a plurality of through holes. Each through hole is filled with an electrolytic material that allows passage of protons but prevents passage of fuel. The aperture ratio of the through holes in the central region of the electrolyte plate 15 is lower than the aperture ratio of the through holes in the peripheral region.

In the fuel cell 10 according to this embodiment, a liquid fuel 100 retained in a liquid fuel tank 26 is vaporized and supplied to the fuel electrode of the membrane electrode assembly 16. On the other hand, oxygen is fed from the external atmosphere to the air electrode of the membrane electrode assembly 16. In the membrane electrode assembly 16, the fuel reacts with oxygen and generates electricity.

Here, the central portion of the membrane electrode assembly 16 has less heat dissipation than the peripheral portion. Hence, if the aperture ratio of the through holes of the electrolyte plate 15 is uniform in the plane, the central region of the membrane electrode assembly 16 has a higher temperature than the peripheral region. Thus the electricity generating reaction is accelerated in the central region of the membrane electrode assembly 16 than in the peripheral region, and the temperature in the central region further increases. As a result, the central region of the electrolyte plate 15 is deteriorated earlier than the peripheral region.

In contrast, according to this embodiment, the aperture ratio of the through holes is lower in the central region of the electrolyte plate 15 than in the peripheral region. Thus passage of protons is made lower in the central region than in the peripheral region. As a result, when the electricity generating reaction in the membrane electrode assembly 16, that is, reaction between the anode and the cathode, reaches a steady state, the temperature distribution is made uniform in the plane of the electrolyte plate 15. This eliminates the situation where a particular region is deteriorated earlier than the other region in the electrolyte plate 15, and increases the overall lifetime of the electrolyte plate 15.

Thus, according to this embodiment, the temperature is made uniform in the plane of the electrolyte plate 15, and the progress of the electricity generating reaction can be prevented from concentrating on the central region. This can realize a fuel cell with an electrolyte plate having a longer lifetime. More specifically, the fuel cell 10 according to this embodiment has a longer cell lifetime than conventional fuel cells because the reaction does not concentrate on a particular region.

Examples for realizing this embodiment will now be described.

To begin with, a first example of this embodiment is described.

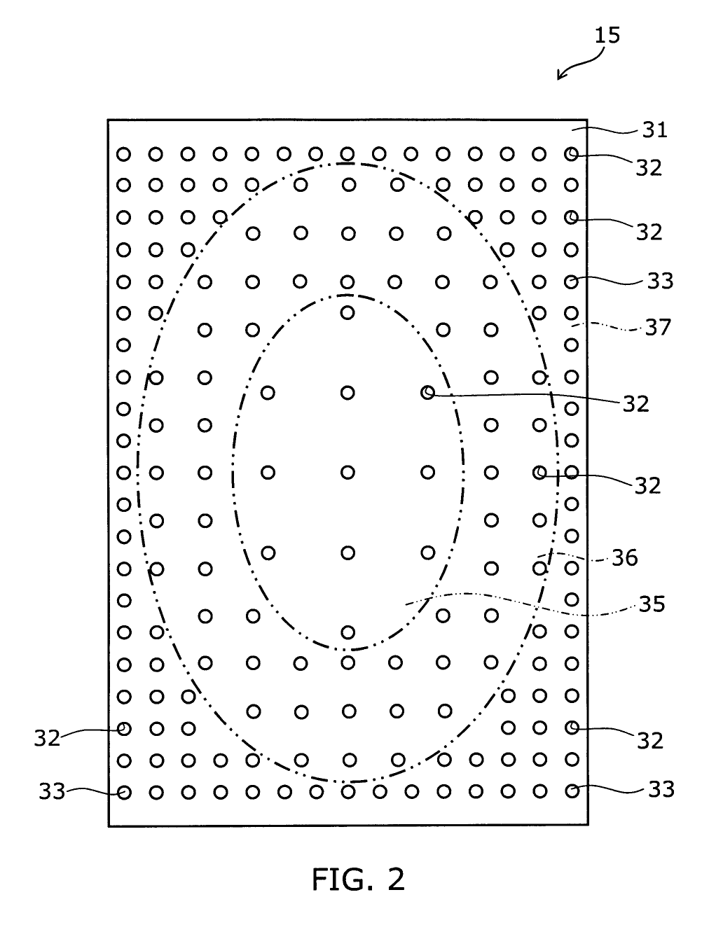

FIG. 2 is a plan view illustrating an electrolyte plate of the fuel cell according to this example.

The electrolyte plate 15 has a matrix 31 shaped like a flat plate. The matrix 31 has a plurality of through holes 32. The through hole 32 is filled with an electrolytic material 33. The matrix 31 is illustratively fabricated by forming a silicon oxide film by thermal oxidation on the surface of a silicon substrate having through holes 32. The electrolytic material 33 is a proton conductive material that prevents passage of a fuel, e.g. methanol, and allows passage of protons, i.e. hydrogen ions (H⁺). The electrolytic material 33 is illustratively a resin material having a sulfonic acid group such as a perfluorosulfonic acid polymer. Examples include Nafion (trade name) manufactured by DuPont Corp. and Flemion (trade name) manufactured by Asahi Glass Co., Ltd.

The electrolytic material 33 only needs to be a material having proton conductivity, and may be an organic material having one or more functional groups selected from the group consisting of a sulfonic acid group, a carboxy group, and a hydroxy group. In the electrolytic material 33, such functional groups form molecular-sized micropores, through which protons can migrate. The micropore has a size through which a proton and a water molecule can pass but a methanol molecule cannot pass.

The electrolytic material 33 may also be a fluorine resin or a hydrocarbon resin. By using a fluorine resin, oxidation resistance and chemical resistance can be improved.

Furthermore, the electrolytic material 33 may contain an ester group or ether group formed by reaction of two or more functional groups from among a sulfonic acid group, carboxy group, and hydroxy group, or may be primarily composed of polytetrafluoroethylene.

As viewed in the direction perpendicular to the major surface, the matrix 31 is divided into three regions: a central region 35, an intermediate region 36, and a peripheral region 37. The central region 35 is an elliptical region including the center of the major surface of the matrix 31. The intermediate region 36 is an elliptical annular region surrounding the central region 35. The peripheral region 37 is a frame region surrounding the intermediate region 36 and including the edge of the matrix 31. The arrangement density of the through holes 32 varies among the regions, lowest in the central region 35 and highest in the peripheral region 37. On the other hand, the diameter of the through hole 32 is constant throughout the regions. As a result, the aperture ratio resulting from the through holes 32 in the electrolyte plate 15 is lowest in the central region 35 and highest in the peripheral region 37. More specifically, the aperture ratio of the through holes 32 in the central region 35 is lower than in the intermediate region 36, and the aperture ratio of the through holes 32 in the intermediate region 36 is lower than in the peripheral region 37. Here, the aperture ratio in a particular region of the major surface of the electrolyte plate refers to the ratio of the sum of the area of through holes to the total area of the particular region.

Next, the configuration of the portions other than the membrane electrode assembly 16 in the fuel cell 10 is described.

A fuel electrode conductive layer 17 is laminated on the surface of the fuel electrode gas diffusion layer 12 on the opposite side of the fuel electrode catalyst layer 11 (hereinafter referred to as “fuel side”). An air electrode conductive layer 18 is laminated on the surface of the air electrode gas diffusion layer 14 on the opposite side of the air electrode catalyst layer 13 (hereinafter referred to as “air side”). A rubber O-ring 19 is provided around the portion between the electrolyte plate 15 and the fuel electrode conductive layer 17, and a rubber O-ring 20 is provided around the portion between the electrolyte plate 15 and the air electrode conductive layer 18. The O-rings 19 and 20 prevent leakage of fuel and oxidizer from the membrane electrode assembly 16. In this fuel cell 10, the fuel is illustratively methanol or a methanol aqueous solution, and the oxidizer is illustratively air.

On the fuel side of the fuel electrode conductive layer 17, a hydrophobic porous membrane 21 and a polymer swelling membrane 22 are laminated in this order. On the further fuel side thereof is provided a frame 23 shaped like the outline of the fuel cell 10 such as a rectangle. On the other hand, on the air side of the air electrode conductive layer 18 is provided a frame 24 shaped like the outline of the fuel cell 10 such as a rectangle. The frames 23 and 24 are illustratively made of a thermoplastic polyester resin such as polyethylene terephthalate (PET). The frames 23 and 24 sandwich and hold a laminated body composed of the polymer swelling membrane 22, the porous membrane 21, the fuel electrode conductive layer 17, the membrane electrode assembly 16, and the air electrode conductive layer 18.

Furthermore, on the fuel side of the frame 23 is laminated a gas-liquid separation membrane 25 that allows passage of only the vaporized component of the liquid fuel and prevents passage of the liquid component. On the further fuel side thereof is provided a liquid fuel tank 26 serving as a fuel supply section. The liquid fuel tank 26 retains and vaporizes a liquid fuel 100 therein. The fuel 100 is a methanol aqueous solution having a concentration exceeding 50 mole % or pure methanol. In the case of pure methanol, its purity is preferably 95 mass % or more. One side of the liquid fuel tank 26 is opened, and this opening serves as a fuel supply port for feeding the vaporized fuel. Therefore the fuel supply port for supplying fuel to the fuel electrode (anode) is located on the opposite side of the electrolyte plate 15 as viewed from the fuel electrode. The gas-liquid separation membrane 25 is disposed so as to occlude this fuel supply port. The gas-liquid separation membrane 25 is illustratively made of silicone rubber.

The space surrounded by the frame 23 between the polymer swelling membrane 22 and the gas-liquid separation membrane 25 is a fuel holding chamber 27 that temporarily holds the vaporized fuel and uniformizes the concentration distribution thereof. The vaporized component of the liquid fuel refers to vaporized methanol when liquid methanol is used as the liquid fuel, and to an air-fuel mixture of the vaporized component of methanol and the vaporized component of water when a methanol aqueous solution is used as the liquid fuel.

Furthermore, on the air side of the frame 24 is laminated a moisturizing layer 28, and on the further air side thereof is provided a surface layer 29. The surface layer 29 has a plurality of air inlets 30 for taking in air as an oxidizer. The surface layer 29 also serves for pressurizing the laminated body including the membrane electrode assembly 16 to enhance the adhesion thereof. Hence the surface layer 29 is illustratively made of an alloy such as SUS304, or a metal.

In the following, each element constituting the fuel cell 10 is described in more detail.

The fuel electrode catalyst layer 11 and the air electrode catalyst layer 13 contain catalysts for accelerating chemical reactions at the fuel electrode and the air electrode, respectively. The catalysts include, for example, elemental metals of the platinum group such as Pt, Ru, Rh, Ir, Os, or Pd, or alloys containing such platinum group elements. Specifically, preferable catalysts contained in the fuel electrode catalyst layer 11 include Pt—Ru and Pt—Mo, which are highly resistant to methanol and carbon monoxide. Preferable catalysts contained in the air electrode catalyst layer 13 include Pt and Pt—Ni. The catalyst may be a supported catalyst using a conductive support such as a carbon material, or may be a non-supported catalyst.

The fuel electrode gas diffusion layer 12 serves to uniformly supply the fuel to the fuel electrode catalyst layer 11, and simultaneously serves as a collector for the fuel electrode catalyst layer 11. On the other hand, the air electrode gas diffusion layer 14 serves to uniformly supply the oxidizer to the air electrode catalyst layer 13, and simultaneously serves as a collector for the air electrode catalyst layer 13. The fuel electrode conductive layer 17 and the air electrode conductive layer 18 are composed of a porous layer made of a conductive material, and are illustratively composed of a mesh made of gold.

The porous membrane 21 is hydrophobic, prevents migration of water from the fuel electrode gas diffusion layer 12 side to the polymer swelling membrane 22 side, and allows passage of the liquid fuel from the polymer swelling membrane 22 side to the fuel electrode gas diffusion layer 12 side. Specific materials of the porous membrane 21 include polytetrafluoroethylene (PTFE) and a water-repellent silicone sheet.

For example, osmosis may accelerate the reaction where the water generated in the air electrode catalyst layer 13 passes through the electrolyte plate 15 and migrates to the fuel electrode catalyst layer 11. In such a situation, the porous membrane 21 disposed between the fuel electrode conductive layer 17 and the polymer swelling membrane 22 can prevent the incoming water from infiltrating into the polymer swelling membrane 22 and the fuel side thereof. Thus it is possible to prevent, for example, reduction of space in the fuel holding chamber 27 due to being filled with water, and vaporization of the fuel 100 in the liquid fuel tank 26 can be advanced without interference. Furthermore, by retaining water between the fuel electrode catalyst layer 11 and the porous membrane 21, the fuel electrode catalyst layer 11 can be replenished with water. This is particularly effective when no moisture is supplied from the liquid fuel tank 26, for example, when pure methanol is used as the fuel. Note that the migration of water from the air electrode catalyst layer 13 side to the fuel electrode catalyst layer 11 side due to osmosis can be adjusted by varying the number and size of the air inlets 30 in the surface layer 29 to adjust the aperture area.

The polymer swelling membrane 22 functions as a fuel concentration adjusting layer for adjusting the concentration and amount of fuel supplied to the fuel electrode catalyst layer 11. More specifically, the polymer swelling membrane 22 absorbs gas-phase methanol, which has been vaporized in the liquid fuel tank 26 and passed through the gas-liquid separation membrane 25, up to a maximum absorbable concentration, i.e. saturation concentration, and supplies the portion of methanol exceeding the saturation concentration to the fuel electrode catalyst layer 11 side. The polymer swelling membrane 22 may be made of a polymer material having such functional groups as hydroxy, carboxy, or sulfonic groups, e.g. cellulose, acrylic, or vinyl polymer material. Specifically, cellulose materials include methyl cellulose, acrylic materials include polybutyl methacrylate, and vinyl materials include polyvinyl butyrate.

The polymer material constituting the polymer swelling membrane 22 is polar because of its functional groups such as hydroxy, carboxy, or sulfonic groups, and can be bound to methanol by the Coulomb force. Thus, even if the amount of methanol vaporized in the fuel tank 26 is varied with external temperature, the polymer swelling membrane 22 can absorb this variation in the amount of methanol. Hence a nearly constant amount of methanol can be supplied to the fuel electrode catalyst layer 11 independent of external temperature. The saturation amount of methanol in the polymer swelling membrane 22, which depends on the functional groups of the polymer constituting the polymer swelling membrane 22, can be adjusted by, for example, adjusting the thickness of the polymer swelling membrane 22.

The polymer swelling membrane 22 reversibly changes its state from a non-gel membrane to a gel membrane with the temperature variation in a prescribed range. For example, the polymer swelling membrane 22 may be made of methyl cellulose. Methyl cellulose is in a non-gel state at normal temperature, and gelled by the thermal gelation effect when the temperature increases to about 50 to 70° C. This thermal gelation effect has reversibility with respect to temperature. When the temperature returns to normal temperature, the gelation is dissolved, and the original non-gel state is recovered.

When the operating temperature of the fuel cell 10 increases to e.g. 50 to 70° C., the vaporization of methanol is accelerated to cause excessive supply of gas methanol in the liquid fuel tank 26. However, because the polymer swelling membrane 22 is gelled, the diffusion rate of methanol in the polymer swelling membrane 22 decreases, and prevents excessive supply of methanol to the fuel electrode. On the other hand, when the temperature decreases to normal temperature and the vaporized amount of methanol in the liquid fuel tank 26 decreases to the normal amount, the polymer swelling membrane 22 returns to the original polymer membrane in the non-gel state, and the diffusion rate of methanol is recovered to the normal level.

Thus the diffusion rate of methanol in the polymer swelling membrane 22 negatively correlates with temperature. Therefore, even if the temperature rises and the vaporized amount of fuel increases, the vaporized fuel is not excessively supplied to the fuel electrode catalyst layer 11, and the occurrence of methanol crossover (MCO) can be prevented. Thus a nearly constant amount of methanol can be supplied to the fuel electrode catalyst layer 11 side independent of external temperature.

The moisturizing layer 28 serves to reduce transpiration of water by being impregnated with part of the water generated in the air electrode catalyst layer 13. Furthermore, the moisturizing layer 28 also serves as an auxiliary diffusion layer for uniformly introducing an oxidizer (air) into the air electrode gas diffusion layer 14 to promote uniform diffusion of the oxidizer into the air electrode catalyst layer 13. The moisturizing layer 28 is illustratively made of a polyethylene porous membrane having a maximum pore diameter of e.g. 20 to 50 microns. The reason for limiting the maximum pore diameter to this range is that a pore diameter of less than 20 microns results in decreased air permeability, whereas a pore diameter of more than 50 microns results in excessive moisture evaporation.

Next, the operation of a fuel cell according to this example configured as above is described.

First, the fuel electrode and the air electrode are connected to an external circuit (not shown). The liquid fuel tank 26 is charged with a liquid fuel 100, e.g. methanol aqueous solution, and the air inlets 30 of the surface layer 29 are exposed to air.

Thus the methanol aqueous solution is vaporized in the liquid fuel tank 26 to generate an air-fuel mixture of methanol vapor and water vapor. This air-fuel mixture flows out of the opening of the liquid fuel tank 26, passes through the gas-liquid separation membrane 25, and is temporarily held in the fuel holding chamber 27. After the concentration distribution is made uniform in the fuel holding chamber 27, this air-fuel mixture infiltrates into the polymer swelling membrane 22, and methanol molecules are adsorbed on the polymer swelling membrane 22. When the polymer swelling membrane 22 reaches saturation, methanol is emitted from the polymer swelling membrane 22, passes through the porous membrane 21 and the fuel electrode conductive layer 17 together with water vapor, diffuses in the fuel electrode gas diffusion layer 12, and is supplied to the fuel electrode catalyst layer 11.

The air-fuel mixture supplied to the fuel electrode catalyst layer 11 undergoes the internal reforming reaction of methanol given by the following formula (1):
CH₃OH+H₂O→CO₂+6H⁺+6e⁻ (1)

When pure methanol is used as the liquid fuel, no water vapor is supplied from the liquid fuel tank 26. Hence, as described below, the water generated in the air electrode catalyst layer 13 and supplied to the fuel electrode catalyst layer 11 through the electrolyte plate 15 is used for the reaction of the above formula (1). Alternatively, without recourse to the internal reforming reaction of the above formula (1), other reaction mechanisms without requiring water can be used to cause an internal reforming reaction.

Electrons (e⁻) generated by the internal reforming reaction given by the above formula (1) reach the air electrode catalyst layer 13 through the external circuit. Protons (H⁺) conduct in the electrolyte plate 15 and reach the air electrode catalyst layer 13. On the other hand, air as an oxidizer is taken in through the air inlets 30 of the surface layer 29, passes through the moisturizing layer 28 and the air electrode conductive layer 18, diffuses in the air electrode gas diffusion layer 14, and is supplied to the air electrode catalyst layer 13.

Electrons, protons, and oxygen in air supplied to the air electrode catalyst layer 13 undergo the reaction given by the following formula (2):
(3/2)O₂+6H⁺+6e⁻→3H₂O (2)

The water generated by this reaction is supplied to the fuel electrode catalyst layer 11 through the electrolyte plate 15 and used for the reaction given by the above formula (1).

Thus, by the electricity generating reaction given by the above formulas (1) and (2), water and carbon dioxide are generated from methanol and aerial oxygen, and electric power is supplied to the external circuit.

Here, heat is generated by the above electricity generating reaction. If the electrolyte plate 15 does not have the matrix 31 and is entirely formed from the electrolytic material 33, then the heat associated with the electricity generating reaction expands the electrolytic material 33, and also expands the micropores formed in the electrolytic material 33. This enables methanol molecules to pass through the micropores and causes methanol crossover.

In contrast, according to this example, the electrolytic material 33 is buried in the through holes 32 of the matrix 31. Hence the electrolytic material 33 is constrained by its periphery, and the thermal expansion is suppressed. Thus the expansion of the micropores in the electrolytic material 33 is also suppressed, and methanol crossover can be prevented. Hence a good initial electricity generating performance is achieved. Even after prolonged use with repeated start and stop of electricity generation, the junction property of the interface between the electrodes and the electrolyte material is kept sound. Therefore high output characteristics can be maintained.

The central portion of the membrane electrode assembly 16 has less heat dissipation than the peripheral portion. Hence, if through holes 32 of the same size are formed uniformly in the plane of the matrix 31 of the electrolyte plate 15, the central region of the membrane electrode assembly 16 has a higher temperature than the peripheral region. Thus the above electricity generating reaction is accelerated in the central region of the membrane electrode assembly 16 than in the peripheral region, and the temperature in the central region further increases. As a result, the central region of the electrolyte plate 15 has an even higher temperature, and is deteriorated earlier, than the peripheral region.

In contrast, according to this example, as described above, the aperture ratio of the through holes 32 is lower in the central region 35 of the electrolyte plate 15 than in the peripheral region 37. Thus passage of protons is made lower in the central region 35 than in the peripheral region 37. Hence, in the central region 35 of the membrane electrode assembly 16, the above electricity generating reaction is suppressed, and the amount of heat generation is reduced, relative to the peripheral region 37. As a result, when the electricity generating reaction in the membrane electrode assembly 16, that is, reaction between the anode and the cathode, reaches a steady state, the temperature distribution is made uniform in the plane of the electrolyte plate 15. This eliminates the situation where a particular region is deteriorated earlier than the other region in the electrolyte plate 15, and increases the overall lifetime of the electrolyte plate 15.

Furthermore, in this example, the fuel cell 10 has a moisturizing layer 28 and a surface layer 29, and air inlets 30 are formed in the surface layer 29. Thus the current output density of the fuel cell 10 can be improved. This operation is now described.

The water generated in the air electrode catalyst layer 13 by the above electricity generating reaction diffuses in the air electrode gas diffusion layer 14 and reaches the moisturizing layer 28. Part of the water that has reached the moisturizing layer 28 is transpirated outside through the air inlets 30 of the surface layer 29, but the rest is blocked from transpiration by the surface layer 29. With the progress of the reaction given by the above formula (2), the amount of water blocked from transpiration by the surface layer 29 increases, the amount of moisture stored in the air electrode catalyst layer 13 increases, and the amount of moisture stored in the air electrode catalyst layer 13 becomes larger than the amount of moisture stored in the fuel electrode catalyst layer 11. As a result, the water generated in the air electrode catalyst layer 13 is more likely to migrate by osmosis through the electrolyte plate 15 to the fuel electrode catalyst layer 11. Therefore, as compared with the case where the supply of moisture to the fuel electrode catalyst layer 11 relies only on water vapor vaporized from the liquid fuel tank 26, the supply of moisture to the fuel electrode catalyst layer 11 is facilitated, and the internal reforming reaction given by the above formula (1) can be accelerated. As a result, the current output density of the fuel cell 10 can be increased, and the increased output density can be maintained for a long period of time.

Next, the effect of this example is described.

As described above, according to this example, the aperture ratio of the through holes 32 is lower in the central region 35 of the electrolyte plate 15 than in the peripheral region 37. Thus the temperature is made uniform in the plane of the electrolyte plate 15, and the progress of the electricity generating reaction can be prevented from concentrating on the central region. Hence the fuel cell 10 can realize a longer cell lifetime than conventional fuel cells because the reaction does not concentrate on a particular region.

Furthermore, according to this example, the moisturizing layer 28 and the surface layer 29 can allow the water generated in the air electrode catalyst layer 13 to efficiently migrate to the fuel electrode catalyst layer 11 for use in the internal reforming reaction. Thus, even if a methanol aqueous solution having a methanol concentration exceeding 50 mole % or pure methanol is used as the liquid fuel, the fuel electrode catalyst layer 11 can be stably supplied with water. Hence it is possible to reduce reaction resistance to the internal reforming reaction of methanol and to improve the long-term output characteristics and load current characteristics. Furthermore, because the methanol concentration in the liquid fuel can be increased, the liquid fuel tank 26 can be downsized.

Furthermore, in this example, a polymer swelling membrane 22 is provided between the gas-liquid separation membrane 25 and the porous membrane 21. Thus, after absorbing vaporized methanol and being saturated therewith, the polymer swelling membrane 22 emits the methanol to the fuel electrode catalyst layer 11 side. Hence the variation of the vaporized amount of methanol in the liquid fuel tank 26 is alleviated, and the fuel electrode catalyst layer 11 can be stably supplied with a prescribed concentration of methanol.

Furthermore, the polymer swelling membrane 22 reversibly changes its state from a non-gel membrane to a gel membrane with the temperature variation in a prescribed range. Thus a nearly constant concentration of methanol can be supplied to the fuel electrode catalyst layer 11 independent of external temperature. Moreover, because the porous membrane 21 is hydrophobic, it is possible to prevent the water in the fuel electrode catalyst layer 11 from infiltrating into the polymer swelling membrane 22 and the gas-liquid separation membrane 25.

Next, a second example of the first embodiment is described.

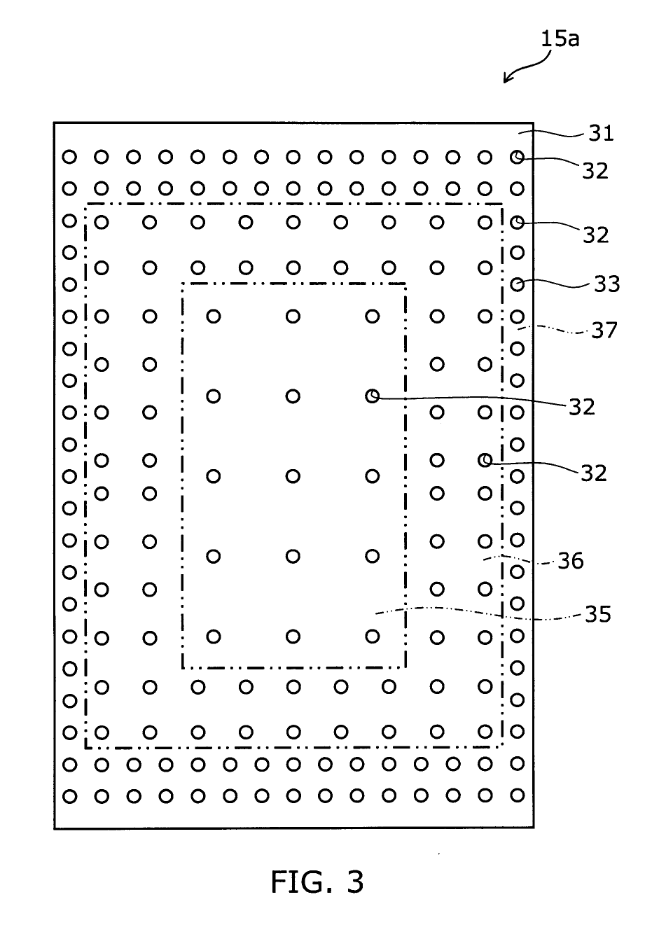

FIG. 3 is a plan view illustrating an electrolyte plate of the fuel cell according to this example.

The fuel cell according to this example is different in the configuration of the electrolyte plate from the fuel cell according to the first example described above. More specifically, in the electrolyte plate 15a of this example, as viewed in the direction perpendicular to the major surface of the electrolyte plate 15a, the central region 35 is shaped like a rectangle. The intermediate region 36 is shaped like a rectangular frame surrounding the central region 35. The peripheral region 37 is shaped like a rectangular frame surrounding the intermediate region 36 and including the edge of the electrolyte plate 15a. The arrangement density of the through holes 32 varies among the regions, lowest in the central region 35 and highest in the peripheral region 37. Thus the aperture ratio resulting from the through holes 32 in the electrolyte plate 15a is lowest in the central region 35 and highest in the peripheral region 37. The configuration, operation, and effect other than the foregoing in this variation are similar to those in the first example described above.

Next, a third example of the first embodiment is described.

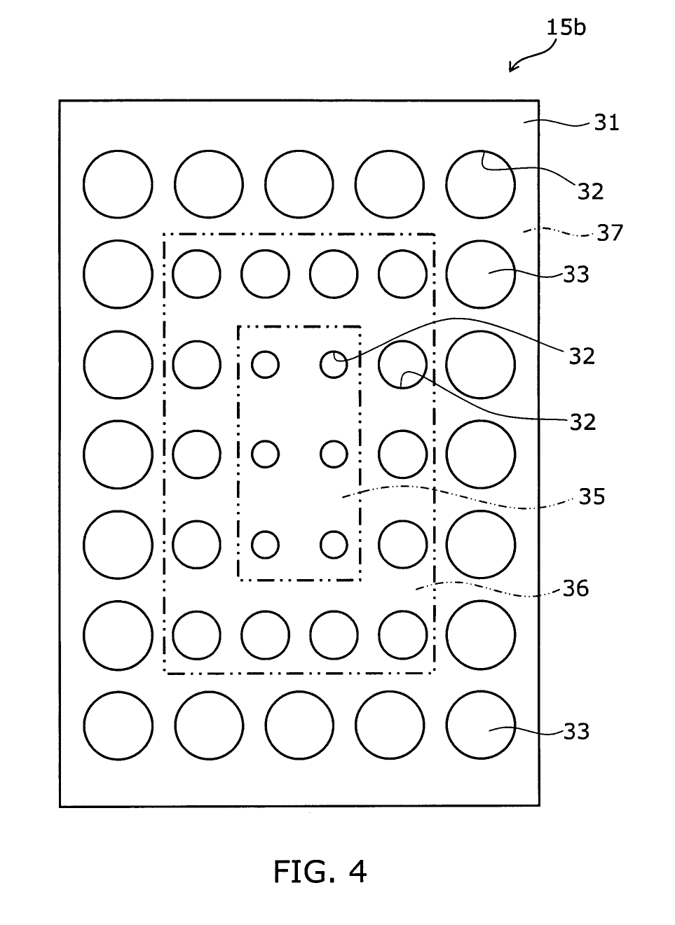

FIG. 4 is a plan view illustrating an electrolyte plate of the fuel cell according to this example.

The fuel cell according to this example is different in the configuration of the electrolyte plate from the fuel cell according to the first example described above. Specifically, the electrolyte plate 15b in this example is, like the second example described above, divided into a rectangular central region 35, and an intermediate region 36 and a peripheral region 37 shaped like rectangular frames. The diameter of the through hole 32 varies among the regions. More specifically, the diameter of the through hole 32 in the central region 35 is smaller than the diameter of the through hole 32 in the intermediate region 36, and the diameter of the through hole 32 in the intermediate region 36 is smaller than the diameter of the through hole 32 in the peripheral region 37. On the other hand, the arrangement density of the through holes 32 is common among the regions. Thus the aperture ratio resulting from the through holes 32 in the electrolyte plate 15b is lowest in the central region 35 and highest in the peripheral region 37. The configuration, operation, and effect other than the foregoing in this example are similar to those in the first example described above.

Next, a second embodiment of the invention is described.

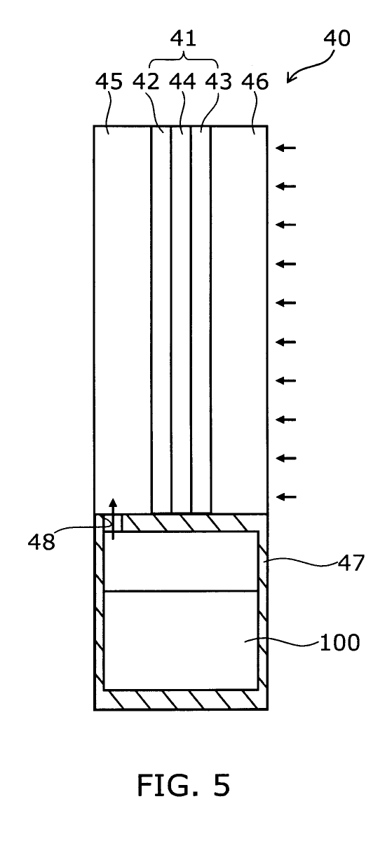

FIG. 5 is a cross-sectional view illustrating a fuel cell according to this embodiment.

A fuel cell 40 according to this embodiment has a membrane electrode assembly (MEA) 41 shaped like a flat plate. The membrane electrode assembly 41 has a fuel electrode 42 and an air electrode 43. An electrolyte plate 44 shaped like a flat plate is placed between the fuel electrode 42 and the air electrode 43. The configuration of the fuel electrode 42 and the air electrode 43 is similar to that in the first embodiment described above.

A fuel side section 45 is provided on the fuel electrode 42 side of the membrane electrode assembly 41. Like the first embodiment, the fuel side section 45 has a fuel electrode conductive layer 17 (see FIG. 1), a porous membrane 21 (see FIG. 1), a polymer swelling membrane 22 (see FIG. 1), and a frame. On the other hand, an air side section 46 is provided on the air electrode 43 side of the membrane electrode assembly 41. Like the first embodiment, the air side section 46 has an air electrode conductive layer 18 (see FIG. 1), a frame, a moisturizing layer 28 (see FIG. 1), and a surface layer 29 (see FIG. 1).

A fuel tank 47 for retaining fuel 100 is provided on one lateral end side of a laminated body composed of the fuel side section 45, the membrane electrode assembly 41, and the air side section 46. A fuel supply port 48 is formed in the portion of the fuel tank 47 in contact with the fuel side section 45. The fuel supply port 48 supplies vaporized fuel to the fuel electrode 42 serving as an anode. Thus the fuel supply port 48 is provided on one end side of the fuel electrode 42. Note that a gas-liquid separation membrane (not shown) is provided in the fuel supply port 48.

The electrolyte plate 44 has a plurality of through holes. Each through hole is filled with an electrolytic material that allows passage of protons but prevents passage of fuel. The aperture ratio of the through holes in the region of the electrolyte plate 44 on the fuel supply port 48 side is lower than the aperture ratio of the through holes in the region on the far side from the fuel supply port 48.

According to this embodiment, in the electrolyte plate 44, the aperture ratio of the through holes is lower in the region on the fuel supply port 48 side than in the region on the opposite side. Thus passage of protons is relatively suppressed in the region on the fuel supply port 48 side. Hence nonuniformity in the supplied amount of fuel due to the difference of the distance from the fuel supply port 48 is canceled, and the density of protons passing through the electrolyte plate 44 is made uniform in the plane. As a result, the electricity generating reaction in the membrane electrode assembly 41 is also made uniform in the plane. Thus the fuel cell 40 according to this embodiment has a longer cell lifetime than conventional fuel cells because the reaction in the cell does not concentrate on a particular region. The operation and effect other than the foregoing in this embodiment are similar to those in the first embodiment described above.

Examples for realizing the second embodiment will now be described.

To begin with, a first example of this embodiment is described.

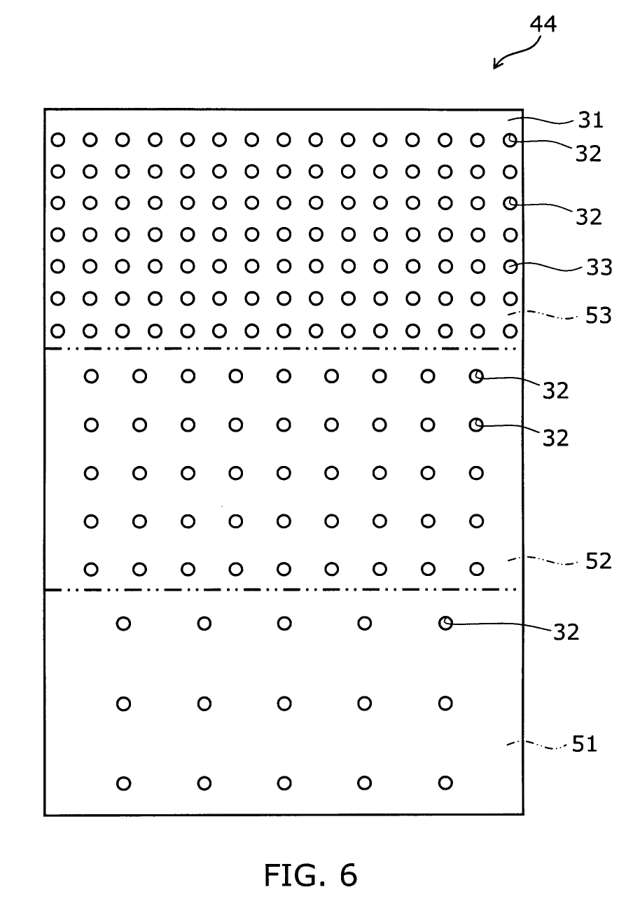

FIG. 6 is a plan view illustrating an electrolyte plate of the fuel cell according to this example.

The electrolyte plate 44 has a matrix 31 shaped like a flat plate where a plurality of through holes 32 are formed. Each through hole 32 is filled inside with an electrolytic material 33. The matrix 31 is divided longitudinally into three regions having a nearly equal width. More specifically, in the matrix 31, from the end portion on the fuel tank 47 side toward the opposite end portion, a first region 51, a second region 52, and a third region 53 are arranged in this order. The regions 51 to 53 are shaped nearly identical to each other, each like a rectangle.

The arrangement density of the through holes 32 varies among the regions, lowest in the first region 51 and highest in the third region 53. On the other hand, the diameter of the through hole 32 is constant throughout the regions. As a result, the aperture ratio resulting from the through holes 32 in the electrolyte plate 44 is lowest in the first region 51, next lowest in the second region 52, and highest in the third region 53. The configuration other than the foregoing in this example is similar to that in the first example of the first embodiment described above.

Next, the operation of a fuel cell according to this example configured as above is described.

In the fuel cell 40, the fuel tank 47 is placed on one lateral end side of a laminated body composed of the fuel side section 45, the membrane electrode assembly 41, and the air side section 46. The fuel side section 45 is supplied with fuel from the fuel supply port 48 of the fuel tank 47. Thus, in the fuel electrode 42, the supplied amount of fuel is larger at the end portion on the fuel tank 47 side than at the opposite end portion.

Therefore, if through holes 32 of the same size are formed uniformly in the plane of the matrix 31 of the electrolyte plate 44, the region of the membrane electrode assembly 41 on the fuel tank 47 side (first region 51) has a larger amount of electricity generating reaction, and also a larger amount of heat generation, than the region on the opposite side (third region 53). As a result, the region of the electrolyte plate 44 on the fuel tank 47 side is deteriorated earlier than the region on the opposite side.

In contrast, according to this example, as described above, the aperture ratio of the through holes 32 is lower in the first region 51 of the electrolyte plate 44 than in the third region 53. Thus passage of protons is made lower in the first region 51 than in the third region 53. More specifically, the passage resistance of protons is higher in the first region 51 than in the third region 53. As a result, the nonuniformity in the amount of fuel supplied to the fuel electrode 42 is canceled by the nonuniformity of the passage resistance of protons in the electrolyte plate 44, and the passage resistance of protons passing through the electrolytic material 33 of the electrolyte plate 44 is made uniform in the plane of the electrolyte plate 44. Thus the electricity generating reaction in the membrane electrode assembly 41 is also made uniform in the plane. Thus the fuel cell according to this example has a longer cell lifetime than conventional fuel cells because the reaction in the cell does not concentrate on a particular region. The operation other than the foregoing in this example is similar to that in the first example of the first embodiment described above.

Next, the effect of this example is described.

As described above, according to this example, the aperture ratio of the through holes 32 is lower in the region of the electrolyte plate 44 on the fuel supply port 48 side (first region 51) than in the region on the opposite side (third region 53). Thus the passage density of protons is made uniform in the plane of the electrolyte plate 44, and the progress of the electricity generating reaction can be prevented from concentrating on the region on the fuel supply port 48 side. This eliminates the situation where a particular region is deteriorated earlier than the other region in the electrolyte plate 44, and increases the overall lifetime of the electrolyte plate 44. Hence a fuel cell having a long lifetime can be realized. The effect other than the foregoing in this example is similar to that in the first example of the first embodiment described above.

Next, a second example of the second embodiment is described.

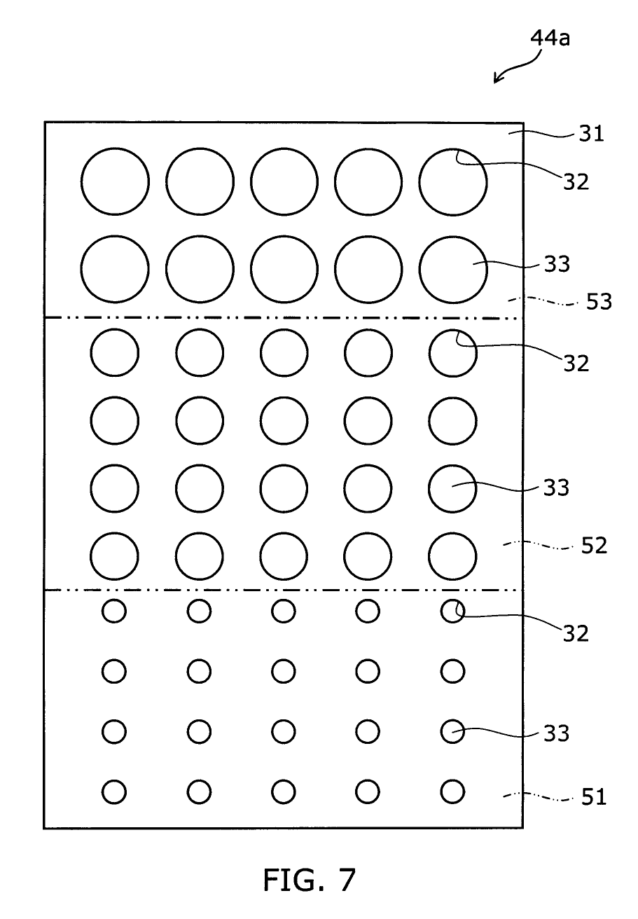

FIG. 7 is a plan view illustrating an electrolyte plate of the fuel cell according to this example.

The fuel cell according to this example is different in the configuration of the electrolyte plate from the fuel cell according to the first example of the second embodiment described above. The electrolyte plate 44a in this example is, like the first example described above, divided into a first region 51, a second region 52, and a third region 53 in sequence from the fuel tank 47 side. The diameter of the through hole 32 varies among the regions. More specifically, the diameter of the through hole 32 in the first region 51 is smaller than the diameter of the through hole 32 in the second region 52, and the diameter of the through hole 32 in the second region 52 is smaller than the diameter of the through hole 32 in the third region 53. On the other hand, the arrangement density of the through holes 32 is common among the regions. Thus the aperture ratio resulting from the through holes 32 in the electrolyte plate 44a is lowest in the first region 51 and highest in the third region 53. The configuration, operation, and effect other than the foregoing in this example are similar to those in the first example described above.

In the examples described in the above embodiments, the electrolyte plate is divided into three regions, and the arrangement density or the diameter of the through holes is varied among the regions. However, the electrolyte plate may be divided into two, or four or more regions. Furthermore, both the arrangement density and the diameter of the through holes may be varied among the regions. In the examples described in the above embodiments, the arrangement density or the diameter of the through holes is varied stepwise. However, the arrangement density or the diameter of the through holes may be varied continuously. Then the aperture ratio in the electrolyte plate can be varied continuously, and the temperature of the electrolyte plate or the passage density of protons can be made uniform with accuracy.

In the above embodiments, a porous membrane (not shown) can be disposed between the polymer swelling membrane 22 and the gas-liquid separation membrane 25 for preventing the polymer swelling membrane 22 from peeling and falling. This porous membrane is preferably disposed so as to be in contact with the surface of the polymer swelling membrane 22 on the liquid fuel tank 26 side. Preferably, this porous membrane is illustratively made of PTFE (polytetrafluoroethylene) or other material, and the maximum pore diameter is 10 to 100 microns. The reason for limiting the maximum pore diameter to this range is that a pore diameter of less than 10 microns results in excessively low permeability of methanol, whereas a pore diameter of more than 100 microns results in passage of liquid methanol.

Furthermore, on the fuel side of the gas-liquid separation membrane 25, it is possible to provide a permeation amount adjusting membrane (not shown) having a gas-liquid separation function like the gas-liquid separation membrane 25 and being capable of adjusting the permeated amount of the vaporized component of fuel. This permeation amount adjusting membrane can be illustratively made of polyethylene terephthalate or other material. The permeated amount of the vaporized component through this permeation amount adjusting membrane can be adjusted by varying the aperture ratio of the permeation amount adjusting membrane. Such a permeation amount adjusting membrane allows the amount of fuel supplied to the fuel electrode to be adjusted.

As described above, for improving current output characteristics, it is preferable to provide a moisturizing layer 28. However, the fuel cell 10 may be configured without a moisturizing layer 28 for its downsizing and cost reduction. In this case, preferably, the surface layer 29 is placed on the frame 24 to adjust the amount of moisture stored and the amount of water transpirated in the air electrode catalyst layer 13. However, the fuel cell 10 may be configured without a surface layer 29.

For uniformizing the concentration distribution of vaporized fuel, it is preferable to provide a fuel holding chamber 27. However, the fuel cell 10 may be configured without a fuel holding chamber 27 for its further downsizing.

In the examples described in the above embodiments, the matrix 31 of the electrolyte plate is fabricated by forming a thermal oxide film on the surface of a silicon substrate. However, the invention is not limited thereto. Chemically stable insulating materials having some rigidity can be used for the matrix 31. For example, the matrix 31 may be fabricated by forming a silicon nitride film on the surface of a silicon substrate. Alternatively, the matrix 31 may be formed from a ceramic material such as silicon oxide, silicon nitride, silicon carbide, aluminum oxide, or aluminum nitride.

In the examples described in the above embodiments, the electrolytic material 33 is an organic material. However, the electrolytic material 33 may be an inorganic material such as tungstic acid or phosphotungstic acid. In such inorganic materials, protons migrate along the crystal grain boundary. Such inorganic materials as tungstic acid and phosphotungstic acid have low strength, and are difficult to singly constitute a plate-like member. However, an electrolyte plate can be formed by burying this inorganic material into the through hole 32 formed in the matrix 31. Also when an inorganic material is used for the electrolytic material 33, the aperture ratio of the through holes 32 can be distributed as described above to uniformize the temperature of the electrolyte plate and extend the lifetime.

In the examples described in the above embodiments, methanol aqueous solution or pure methanol is used as the liquid fuel. However, the invention is not limited thereto. As the liquid fuel, it is also possible to use, for example, ethyl alcohol, isopropyl alcohol, butanol, or dimethyl ether or aqueous solution thereof. Furthermore, aqueous solutions of saccharides such as glucose and sugar can also be used as the liquid fuel.

### WORKING EXAMPLE

The effect of a working example of the invention is described in comparison with a comparative example.

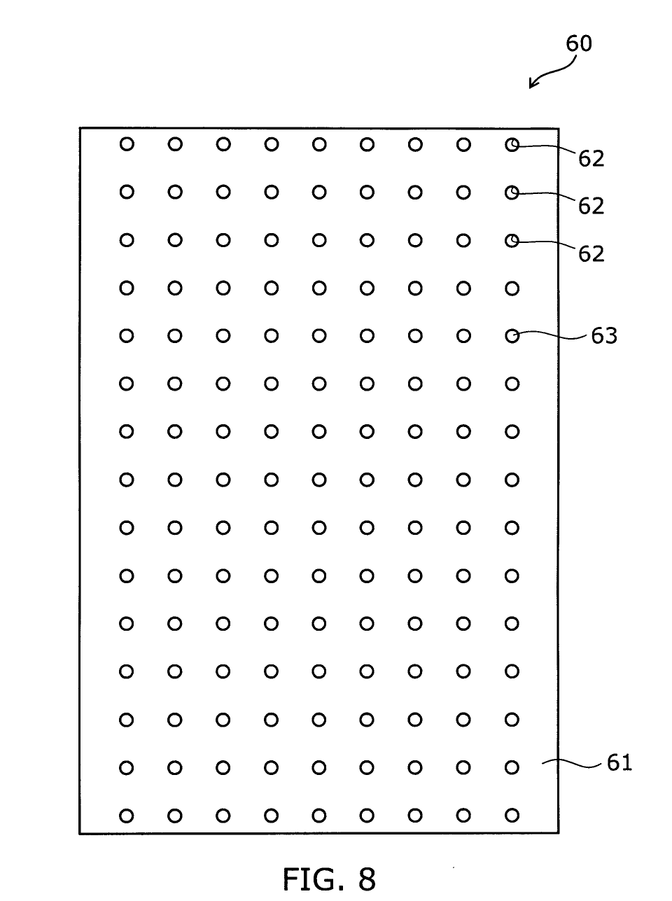

FIG. 8 is a plan view showing an electrolyte plate of a fuel cell according to a comparative example.

As a working example of the invention, a fuel cell as described above in the first example of the first embodiment, that is, a fuel cell having an electrolyte plate with nonuniform aperture ratio, was fabricated. On the other hand, as a comparative example, a fuel cell was fabricated, where through holes 62 of the same size were uniformly formed in the matrix 61 of an electrolyte plate 60, and hence the aperture ratio resulting from the through holes 62 was uniform in the plane. The through hole 62 was filled inside with an electrolytic material 63. Furthermore, as another comparative example, a fuel cell having a continuous electrolyte membrane (Nafion membrane) instead of an electrolyte plate was fabricated. Then these fuel cells were characterized.

A method for manufacturing a fuel cell according to the working example of the invention and a fuel cell according to the comparative examples is now described. Both the fuel cells are identical in configuration except the distribution of through holes formed in the electrolyte plate, and the manufacturing method thereof is also in common. In the following description, for the sake of clarity, each component constituting the fuel cell is marked with the reference numeral shown in FIGS. 1 and 2.

First, graphite-supported platinum particles were mixed with a perfluorosulfonic acid resin solution using a homogenizer to prepare a slurry. The slurry was applied to a carbon paper serving as an air electrode gas diffusion layer. The applied slurry was dried at normal temperature to prepare an air electrode. That is, the dried slurry served as an air electrode catalyst layer 13, and the carbon paper served as an air electrode gas diffusion layer 14.

On the other hand, platinum-ruthenium alloy fine particles supported on carbon particles are mixed with a perfluorosulfonic acid resin solution using a homogenizer to prepare a slurry. The slurry was applied to a carbon paper serving as a fuel electrode gas diffusion layer. The applied slurry was dried at normal temperature to prepare a fuel electrode. That is, the dried slurry served as a fuel electrode catalyst layer 11, and the carbon paper served as a fuel electrode gas diffusion layer 12.

The electrolyte plate 15 was fabricated as follows. First, an N-type silicon substrate was prepared. The crystal orientation of the major surface of this silicon substrate was (100) surface. This silicon substrate was thermally oxidized to form a thermal oxide film having a thickness of 100 nanometers on the surface.

Next, on this silicon substrate, a resist film having a pattern of through holes was grown by lithography. Here, to form the electrolyte plate of the working example of the invention, the pattern as shown in FIG. 2 was used as a resist pattern. To form the electrolyte plate of the comparative example, the pattern as shown in FIG. 8 was used. This resist was used as a mask to selectively etch away and pattern the silicon oxide film with buffered hydrofluoric acid. Next, the resist was peeled with sulfuric acid/hydrogen peroxide solution.

Next, the patterned silicon oxide film was used as a mask to etch the silicon substrate with KOH aqueous solution, thereby forming pits on the major surface of the silicon substrate. Next, photoanisotropic etching was conducted in ethanol/hydrofluoric acid to selectively etch the pit positions. Subsequently, the backside of the silicon substrate was entirely etched with fluoronitric acid to reduce the thickness of the silicon substrate. Thus through holes 32 were formed at the positions where the pits were formed. Next, this silicon substrate was heated to a temperature of 800° C. for thermal oxidation, thereby forming a silicon oxide film on the surface of the silicon substrate. Thus the matrix 31 was fabricated.

Next, a fluorine resin such as a perfluorosulfonic acid polymer, specifically Nafion (trade name) manufactured by DuPont Corp., was buried in the through holes 32 as an electrolytic material 33. Thus the electrolyte plate 15 was fabricated.

The electrolyte plate 15 thus fabricated was held between the air electrode and the fuel electrode described above. Here, the air electrode catalyst layer 13 and the fuel electrode catalyst layer 11 were made in contact with the electrolyte plate 15. Then it was pressed under the condition of a temperature of 120° C. and a pressure of 30 kgf/cm² to fabricate a membrane electrode assembly (MEA) 16. Here, the area of the electrode was 12 cm² for both the air electrode and the fuel electrode.

Next, this membrane electrode assembly 16 was sandwiched between two gold foils having a plurality of holes. These gold foils served as a fuel electrode conductive layer 17 and an air electrode conductive layer 18, and the holes formed in the gold foils served to take in vaporized methanol and air.

Next, a hydrophobic porous membrane 21 made of polytetrafluoroethylene was formed on the surface of the fuel electrode conductive layer 17. On the opposite side (fuel side) of the porous membrane 21 other than the fuel electrode conductive layer side, methyl cellulose dissolved in water was applied to a thickness of about 20 microns and sufficiently dried at normal temperature. Thus a polymer swelling membrane 22 was formed.

The polymer swelling membrane 22, the porous membrane 21, the fuel electrode conductive layer 17, the membrane electrode assembly 16, and the air electrode conductive layer 18 thus prepared were laminated in this order into a laminated body, which was sandwiched between two resin frames 23 and 24. For sealing, an O-ring 19 was placed between the electrolyte plate 15 and the frame 23 on the fuel electrode side, and an O-ring 20 was placed between the electrolyte plate 15 and the frame 24 on the air electrode side.

Next, on the frame 23 side of the laminated body including the frames and the O-rings, a gas-liquid separation membrane 25 made of a silicone sheet and a liquid fuel tank 26 were placed. The frame 23 was screwed to the liquid fuel tank 26 via the gas-liquid separation membrane 25.

On the other hand, a porous plate was placed on the frame 24 on the air electrode side to form a moisturizing layer 28. A stainless steel plate was prepared, which was made of stainless steel (SUS304), had 64 openings with a diameter of 4 millimeters, and had a thickness of 2 millimeters. The stainless steel plate was placed on the air side of the moisturizing layer 28 and screwed to the frame 24. Thus this stainless steel plate served as a surface layer 29, and the openings formed in the stainless steel plate served as air inlets 30 for air intake.

Thus a fuel cell 10 was fabricated.

A thermocouple was attached to the surface of the surface layer 29 of the fuel cell 10 fabricated as above. Furthermore, 5 milliliters of pure methanol was injected into the liquid fuel tank 26. In the environment of a temperature of 25° C. and a relative humidity of 50%, the maximum output was measured from the values of current and voltage. The maximum surface temperature of the fuel cell was measured by the thermocouple. Furthermore, the fuel cell 10 was operated for a prescribed period of time with repeating the cycle of starting and stopping electricity generation, and then the MEA section was taken out and observed.

According to the measurement, in the fuel cell of the working example of the invention, the maximum output was 12.2 mW/cm², and the maximum surface temperature was 32.4° C. In the working example of the invention, the reduction of output with the elapsed time of operation was relatively small. On the other hand, in the above comparative example (fuel cell having a uniform electrolyte plate shown in FIG. 8) and the other comparative example (fuel cell having a continuous electrolyte membrane), the reduction of output with the elapsed time of operation was relatively large. Upon observation of the MEA section, in the working example of the invention, the interface between the electrodes and the electrolytic material was kept sound. On the other hand, in the above other comparative example, peeling was observed at the interface between the electrodes and the electrolyte membrane.

1. A fuel cell which generates electricity by using a fuel and oxygen, comprising:
an anode;
a cathode; and
a plate-like member provided between the anode and the cathode,
the plate-like member including:
a matrix having a plurality of through holes; and
an electrolytic material buried in the through holes, the electrolytic material allowing passage of protons and preventing passage of the fuel, and
the through holes having an aperture ratio distributed in the plate-like member so that the plate-like member has a uniform in-plane temperature when reaction between the anode and the cathode reaches a steady state.

2. The fuel cell according to claim 1, wherein a fuel supply port configured to supply the fuel to the anode is placed on the opposite side of the plate-like member as viewed from the anode, and the aperture ratio of the through holes in a central region of the plate-like member is lower than the aperture ratio of the through holes in a peripheral region of the plate-like member.

3. The fuel cell according to claim 1, wherein a fuel supply port configured to supply the fuel to the anode is placed on one end side of the anode, and the aperture ratio of the through holes in a region on the one end side of the plate-like member is lower than the aperture ratio of the through holes in a region on the other end side of the plate-like member.

4. The fuel cell according to claim 1, wherein the electrolytic material is an organic material having proton conductivity.

5. A fuel cell which generates electricity by using a fuel and oxygen, comprising:
an anode;
a cathode; and
a plate-like member provided between the anode and the cathode,
the plate-like member including:
a matrix having a plurality of through holes; and
an electrolytic material buried in the through holes, the electrolytic material allowing passage of protons and preventing passage of the fuel, and
the through holes having an aperture ratio distributed in the plate-like member so that the plate-like member has a uniform in-plane proton passage density when reaction between the anode and the cathode reaches a steady state.

6. The fuel cell according to claim 2, wherein a fuel supply port configured to supply the fuel to the anode is placed on the opposite side of the plate-like member as viewed from the anode, and the aperture ratio of the through holes in a central region of the plate-like member is lower than the aperture ratio of the through holes in a peripheral region of the plate-like member.

7. The fuel cell according to claim 6, wherein the arrangement density of the through holes in the central region is lower than the arrangement density of the through holes in the peripheral region.

8. The fuel cell according to claim 5, wherein a fuel supply port configured to supply the fuel to the anode is placed on one end side of the anode, and the aperture ratio of the through holes in a region on the one end side of the plate-like member is lower than the aperture ratio of the through holes in a region on the other end side of the plate-like member.

9. The fuel cell according to claim 8, wherein the arrangement density of the through holes in the region on the one end side is lower than the arrangement density of the through holes in the region on the other end side.

10. The fuel cell according to claim 8, wherein the size of the through hole in the region on the one end side is smaller than the size of the through hole in the region on the other end side.

11. The fuel cell according to claim 5, wherein the electrolytic material is an organic material having proton conductivity.

12. A fuel cell which generates electricity by using a fuel and oxygen, comprising:
an anode;
a cathode; and
a plate-like member provided between the anode and the cathode and allowing passage of protons,
the plate-like member including:
a matrix having a plurality of through holes; and
an electrolytic material buried in the through holes, the electrolytic material allowing passage of protons and preventing passage of the fuel, and
a fuel supply port configured to supply the fuel to the anode being placed on the opposite side of the plate-like member as viewed from the anode, and the aperture ratio of the through holes in a central region of the plate-like member being lower than the aperture ratio of the through holes in a peripheral region of the plate-like member.

13. The fuel cell according to claim 12, wherein the arrangement density of the through holes in the central region is lower than the arrangement density of the through holes in the peripheral region.

14. The fuel cell according to claim 12, wherein the size of the through hole in the central region is smaller than the size of the through hole in the peripheral region.

15. The fuel cell according to claim 12, wherein the electrolytic material is an organic material having proton conductivity.

16. A fuel cell which generates electricity by using a fuel and oxygen, comprising:
an anode;
a cathode; and
a plate-like member provided between the anode and the cathode and allowing passage of protons,
the plate-like member including:
a matrix having a plurality of through holes; and
an electrolytic material buried in the through holes, the electrolytic material allowing passage of protons and preventing passage of the fuel, and
a fuel supply port configured to supply the fuel to the anode is placed on one end side of the anode, and the aperture ratio of the through holes in a region on the one end side of the plate-like member being lower than the aperture ratio of the through holes in a region on the other end side of the plate-like member.

17. The fuel cell according to claim 16, wherein the arrangement density of the through holes in the region on the one end side is lower than the arrangement density of the through holes in the region on the other end side.

18. The fuel cell according to claim 16, wherein the size of the through hole in the region on the one end side is smaller than the size of the through hole in the region on the other end side.

19. The fuel cell according to claim 16, wherein the electrolytic material is an organic material having proton conductivity.

20. The fuel cell according to claim 19, wherein the organic material has one or more functional groups selected from the group consisting of a sulfonic acid group, a carboxy group, and a hydroxy group.
